(19) United States
(12) Patent Application Publication
(10) Pub. No.: US 2006/0116992 A1
(43) Pub. Date: Jun. 1, 2006

(54) Internet search environment number system

(75) Inventors: Matthew S. Theobald, Indianapolis, IN (US); Paul Thompson, Hanover, NH (US)

Correspondence Address: SOMMER BARNARD ATTORNEYS,P.C., ONE INDIANA SQ, SUITE 3500, INDIANAPOLIS, IN, 46204, US

(73) Assignee: ISEN, L.L.C.

(21) Appl. No.: 11/287,760

(22) Filed: Nov. 28, 2005

Related U.S. Application Data
(60) Provisional application No. 60/630,982, filed on Nov. 26, 2004.

(51) Int. Cl. G06F 17/30

(52) U.S. Cl. 707/3

(57) ABSTRACT

The present invention discloses an Internet search environment number (“ISEN”) system that provides researchers with a tool to locate and search relevant, evaluated online databases. The ISEN system is a portal that comprehensively catalogs the Internet's databases thereby making information located on the Internet readily accessible from both visible and invisible database resources. The ISEN system facilitates access and adds value by creating more effective and efficient Internet search experiences. The ISEN system takes advantage of a persistent locator for database resources to guarantee users will always be able to locate desired resources no matter where they move or if the content changes.

### CROSS-REFERENCE To RELATED APPLICATIONS

This application claims priority to and the benefit of U.S. provisional application Ser. No. 60/630,982 filed on Nov. 26, 2004.

### BACKGROUND OF THE INVENTION

1. Technical Field

The present invention relates generally to database searching and more particular, to a method and system for assigning an internet search environment number to databases thereby providing a manner in which Internet databases may be comprehensively catalogued and more easily and accurately searched.

2. Related Art

Over the last fifteen years, the Internet has evolved well beyond file transfer protocol (“FTP”) archives to become a graphically rich environment that allows users to search and access information through the assistance of web browsers such as Netscape® and Internet Explorer® and various available search engines. Before web browsers, one tool available for managing data on the Internet was referred to as a Wide Area Information Server (“WAIS”), which is a database that contains indexes to documents that reside on the Internet and allows users to search text files based on keywords and was introduced in approximately 1988.

A variation of WAIS was subsequently released and referred to as XWAIS, which provided a user-friendly graphical user interface (“GUI”) way to find information. The problem with WAIS and XWAIS was that it required servers to organize information contained in the database in a specific format that was not very user friendly. Archie is another Internet utility that was developed about the same time as WAIS and allowed users to search for file names. Periodically, Archie servers searched FTP sites throughout the Internet and recorded information about the files they found, thereby allowing users to use Archie to locate documents in various databases based on file names.

Gopher, which was released in approximately 1991, was another manner in which documents stored in databases could be searched on the Internet. Gopher is a program that searches for file names and resources on the Internet and presents hierarchical menus to the user. As users select options, they are moved to different Gopher servers on the Internet where links have been established to relevant data. Veronica was developed shortly after Gopher and is a program that searches the Internet for specific resources by description, not just file name. Using Boolean searches, users can search Gopher servers to retrieve a selected group of menus that pertain to their area of interest.

In 1993 Marc Andreessen, Eric Bina and their team at the University of Illinois National Center For Supercomputing Applications (“NCSA”) developed a graphical browser named Mosaic. It was the first multimedia browser for the web, which allowed text, images, sound and video to be accessed via a graphical user interface. Andreessen and Bina later went to work for Mosaic Corporation, which was formed to market Mosaic, but wound up developing the Netscape® browser and the company was renamed Netscape and the Netscape® browser reigned supreme for a short period of time. The University of Illinois eventually licensed Mosaic to Spyglass, Inc., which Microsoft acquired and the Mosaic browser ultimately turned into what is now known as Internet Explorer®.

Over the past five to ten years, various Internet search engines have been developed to assist Internet users locate information contained on the Internet. Some of the more popular search engines today are located at the URL's of Google.com, Yahoo.com, AltaVista.com, MetaCrawler.com, Lycos.com, Excite.com, and WebCrawler.com. A search engine is a program that searches documents for specified keywords and returns a list of the documents where keywords were found.

The term search engine is often used to describe both spider based search engines and human based directories. Spider based search engines create their listings automatically. Typically, a spider or crawler is sent out to fetch as many documents or web pages as possible. Another program, called an indexer, then reads these documents or web pages and creates an index based on the words contained in each document or web page. Each search engine uses a proprietary search algorithm to “create” its indices such that, ideally, only meaningful results are returned for a search query. However, if a web page is changed or its location changes, spider based search engines may lose these changes, which may affect a user's ability to locate relevant information.

Human based directories depend on humans for their listings. An entity desiring to be listed typically submits a short description to the directory for the entire site or editors write one for sites that they review. A search is limited to matches only in the descriptions submitted. In human based directories, changes made to a website typically have no effect on a listing returned in response to a search query. Today, many of the major search engines on the Internet are hybrid search engines that use a combination of both spider based search engine technology and human based directory technology.

It has been estimated that the largest of the popular Internet search engines index less than 25 percent of the Web. There are a number of reasons for this, not the least of which is the rapidly expanding nature of the Web and the fact that there are tens of thousands of databases on the Internet that are constantly being changed, updated or relocated. In addition, most of the Web's detailed content is buried far down on dynamically generated sites and spiders never find it. As a result, the “deep”, “hidden”, or “invisible” web contains much more information than is indexed by today's search engines and as such, searchers never have access to this information. Some analysts estimate that as much as 400 to 550 times more information is available on the deep or hidden web than the visible web. Invisible web information exists in databases and database-driven websites that are not located by spider or human based directory solutions. In addition, most analysts agree that the content or information contained in the deep web is much more valuable than that located on the visible web.

As a result of the aforementioned problems, a need exists for a method and system of identifying databases on the web so that content located in the deep or invisible web as well as the visible web may be quickly and easily located by researchers.

### SUMMARY OF THE INVENTION

The present invention discloses an internet search environment number (“ISEN”) system that provides researchers with a tool to locate and search relevant, evaluated online databases. The ISEN system is a portal that comprehensively catalogs the Internet's databases thereby making information located on the Internet readily accessible from both visible and invisible database resources. The ISEN system facilitates access and adds value by creating more effective and efficient Internet search experiences. The ISEN system takes advantage of a persistent locator for database resources to guarantee users will always be able to locate desired resources no matter where they move or if the content changes. The ISEN system corresponds to the database subnet Internet Protocol address and pings database servers regularly to ensure uptime. A metadata record located on a central ISEN server will be collected on the web page of a database interface and on a database server in order to provide the database owner with information about data contained on their database for information auditing purposes.

The ISEN system also provides information owners and vendors with more exposure of their information to a broader range of Internet researchers. The ISEN system will provide a new library standard in organizing databases for the Internet. The ISEN system may be used by individuals, small entities, large entities, government organizations, and educational institutions. The ISEN system will provide an auditing tool for organizations and individuals to find refined and structured resources that have been lost or obscured by the rapid and overwhelming growth of web pages.

The ISEN system may be viewed somewhat to databases as the ISBN is to books. Classification within the ISEN system focuses on databases, making the ISEN system a database of databases. Cataloging is performed by database catalogers as independent agents or stewards to ensure the integrity of database summaries. The ISEN system gives users a search service to find the databases that are relevant to their questions. The ISEN system provides access to a broader scope of information than is available through current search technology options.

The ISEN system supports several activities for several classes of administrative users, as well as general searchers on the Internet. A database provider will have a web interface through which the database provider can create a draft metadata record for the database's inclusion in the ISEN system. An ISEN editor, or classifier, will have an ISEN interface that supports review and modification of the ISEN metadata and classification of the database. The ISEN system may track somewhat closely the Library of Congress classification scheme for example.

The ISEN system allows searchers on the Internet to find more reliable, authoritative information than can be found with conventional search engines. The ISEN system may support quick and advanced searching through an uncluttered search interface. A searcher will enter a quick search into a textbox. Alternatively, the searcher will click on a link to an advanced search option, where the searcher can fill in a template specifying a search more precisely. In addition to these primary uses of ISEN, the ISEN system may also provide an environment in which other companies will be able to provide value-added services building on the rich foundation of metadata provided by the ISEN system. These secondary uses include those made by metasearch, data mining, and search optimization companies.

Other systems, methods, features and advantages of the invention will be, or will become apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 depicts an illustrative hardware configuration of the ISEN system.

FIG. 2 represents a block diagram of some of the components of the ISEN system.

FIG. 3 represents an illustrative main menu of the ISEN system.

FIG. 4 represents an illustrative user interface for a database listing submission.

FIG. 5 is a block diagram of some of the process steps performed by a metadata record creation software module of the ISEN system.

FIG. 6 illustrates a portion of a proposed metadata record.

FIG. 7 illustrates more of the proposed metadata record.

FIG. 8 illustrates more of the proposed metadata record.

FIG. 9 illustrates more of the proposed metadata record.

FIG. 10 illustrates process steps performed to submit and store a metadata record in the ISEN database.

FIG. 11 illustrates an alternative hardware configuration for the ISEN system.

FIG. 12 illustrates a search graphical user interface of the ISEN system.

FIG. 13 illustrates a search result graphical user interface of the ISEN system.

FIG. 14 illustrates an advanced search graphical user interface of the ISEN system.

### DETAILED DESCRIPTION OF THE PRESENTLY PREFERRED EMBODIMENTS

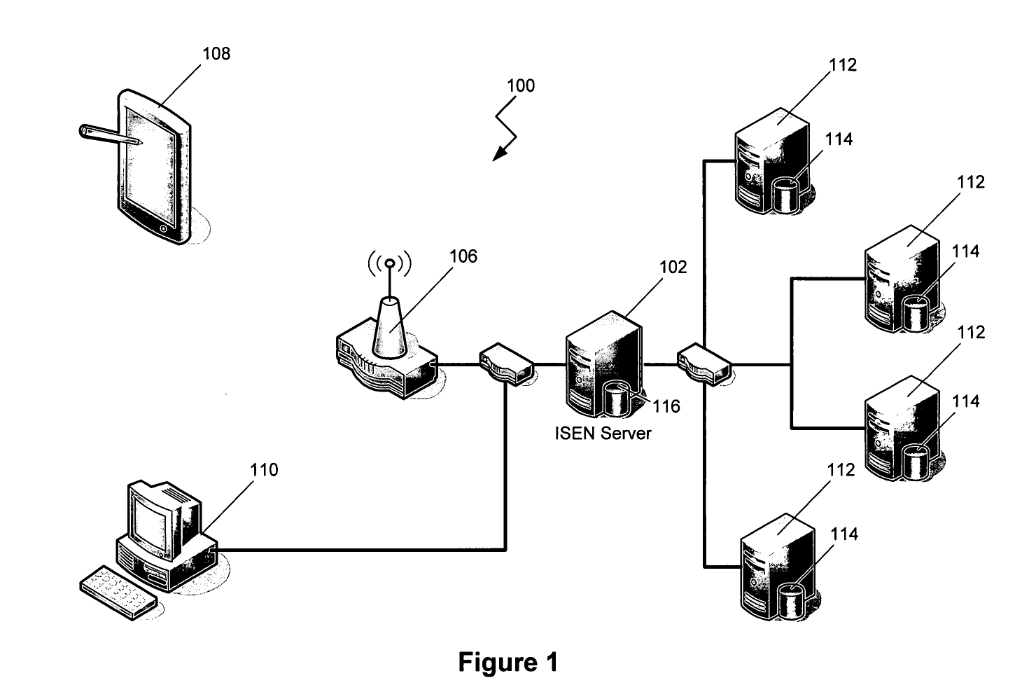

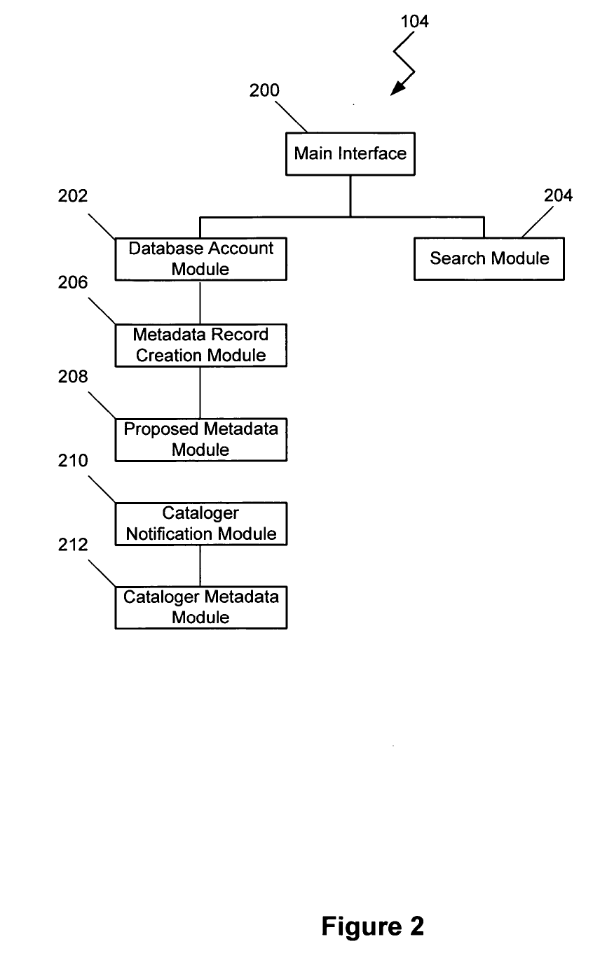

Referring to FIG. 1, an illustrative hardware configuration for an Internet Search Environment Number (“ISEN”) system 100 is depicted that is operable to allow searchers on the Internet to find more reliable and authoritative information than can be found with existing search engines. The ISEN system 100 supports a quick and advanced search through an uncluttered and private search engine. The ISEN system 100 may include an ISEN server 102 that includes an ISEN software application 104 (see FIG. 2) that is operable to perform a plurality of tasks, which are set forth in greater detail below.

The ISEN server 102 may be connected with a wireless router 106 that is operational to wirelessly transmit and receive data between the ISEN server 102 and a variety of different devices, such as tablet or pocket personal computers (“PCs”) 108. The ISEN server 102 may also be connected with a plurality of remote terminals (e.g.

PC workstations) 110 through various types of wired networks designed to allow the ISEN server 102 and the remote terminals 110 to transmit and receive data between respective devices. The ISEN server 102 may also be connected with a plurality of proprietary database servers 114. Those skilled in the art would recognize that the ISEN system 100 may operate, function and be accessed through various types of wired or wireless network hardware setups and configurations. In addition, although the ISEN software application 104 may be accessed through tablet PCs 108, the discussion below will focus on remote terminals 110 for the sake of brevity.

Referring to FIG. 2, the ISEN software application 104 may include a plurality of software modules that may run on the ISEN server 102, the tablet PCs 108 or the remote terminals 20. The ISEN software application 104, or at least certain respective portions of it, may be designed as a “thin” or “fat” client. Preferentially, the ISEN software application 104 is developed to optimize the performance of the tablet PCs 108 and remote terminals 110. As such, most of the data described below may be stored on the ISEN server 102 and the calculations or processes performed by the ISEN software application 104 may be performed by the ISEN server 102 and the results may be “pushed” to the tablet PCs 108 or remote terminals 110. Those skilled in the art would recognize that various configurations exist and that the ISEN software application 14 may be optimally designed in a web-based accessible format by users employing browser software applications commonly known in the art.

The ISEN software application 104 may include a main user interface module 200 that may include a database account module 202 and a search module 204. As set forth in greater detail below, the database account module 202 allows owner's of a respective proprietary database 114 located on a database server 112 to register the proprietary database 114 in an ISEN database 116 located on the ISEN server 102. The database account module 202 allows the owner's to submit certain data or information about the proprietary database 114 to the ISEN software application 104 that will in turn, catalogue and assign an ISEN to the proprietary database 114. Users of the Internet, which may be accessed via browsers located on the remote terminals 110, may then access the search module 204 of the ISEN system 100 to search and locate more relevant results to search queries than prior art search engines.

The ISEN software application 104 may include a metadata record creation module 206 that may be associated with the Internet search environment number server 102 that may be operable to allow a user to enter a designate universal resource locator assigned to the proprietary database 114. The metadata record creation module 206 may be operable to establish a connection with at least one web based file designated by the universal resource locator. The metadata record creation module 206 is operable to extract metadata from the at least one web based file. The metadata record creation module 206 may also be operable to automatically generate a proposed metadata record associated with the proprietary database 114. The proposed metadata record may include an Internet search environment number that comprises a unique and persistent identifier that is automatically generated and assigned to the proprietary database 114 by the metadata record creation module 206.

A proposed metadata module 208 may be operable to generate a proposed metadata record as a function of metadata contained in the at least one web based file and present the proposed metadata record to the user or database owner. The proposed metadata module 208 may allow the database owner to review and edit select portions of the proposed metadata record. The proposed metadata module 208 is further operable to allow the user to submit the proposed metadata record to the Internet search environment number server 102.

A cataloger notification module 210 may be included for notifying a cataloger/editor at ISEN of receipt of the proposed metadata record, which may take the form of an email or some other form of electronic notification. A cataloger metadata module 212 may be operable to allow the cataloger to review and edit the proposed metadata record after receipt by the Internet search environment number server 102. The cataloger may contact the user or database owner to go over the proposed metadata record. The proposed metadata record may be placed in an Internet search environment number database 116 associated with the Internet search environment number server 102 as a final metadata record after the cataloger and the user or database owner have reviewed the proposed metadata record.

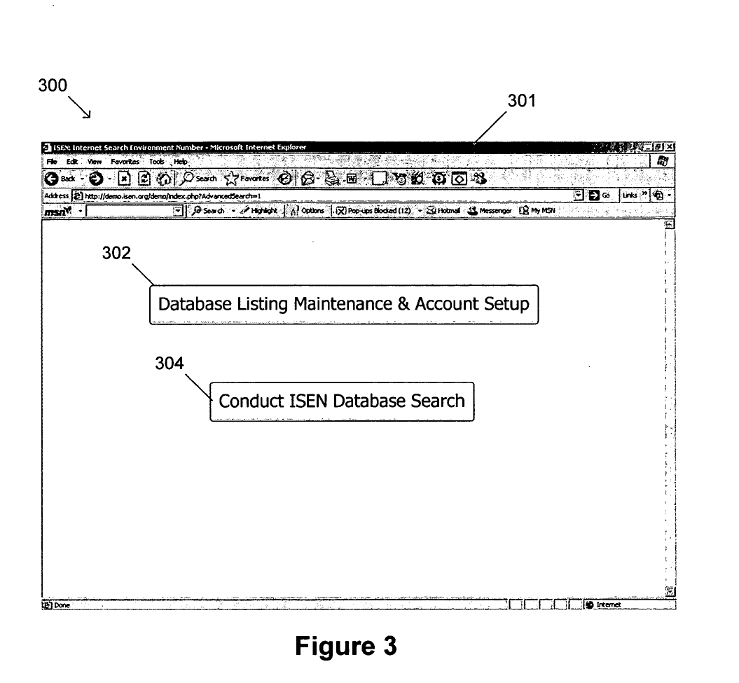

Referring to FIG. 3, the main user interface module 200 may be operable to generate a main graphical user interface (“GUI”) 300 on a respective remote terminal 110 when a user enters a respective universal resource locator (“URL”—(e.g.—www.isen.org)) in a web browser 301. As known in the art, a URL is the address that defines the route to a file on an Internet server (Web server, FTP server, mail server, etc.), which, as it relates to the present invention, corresponds to the proprietary database 114 that a user desires to register with the ISEN system 100. URLs are typed into a web browser 301 to access web pages and files, and URLs are embedded within the pages themselves as hypertext links. The URL typically contains the protocol prefix, port number, domain name, subdirectory names and file name. If a port number is not stated in the address, port 80 is used as the default for HTTP traffic.

The main GUI 300 may include a database account command button 302 and a search command button 304. It is important to note that the exact look and feel of the main GUI 300, or any GUI disclosed herein, is not important and those skilled in the art of website design would clearly recognize that the GUIs, which may be accessed via a web browser 301 on remote terminals 110, may take on many different ornamentations or forms. The main GUI 300 illustrated in FIG. 3, as well as all of the GUIs illustrated herein, should be viewed in an illustrative sense and not in a restrictive sense.

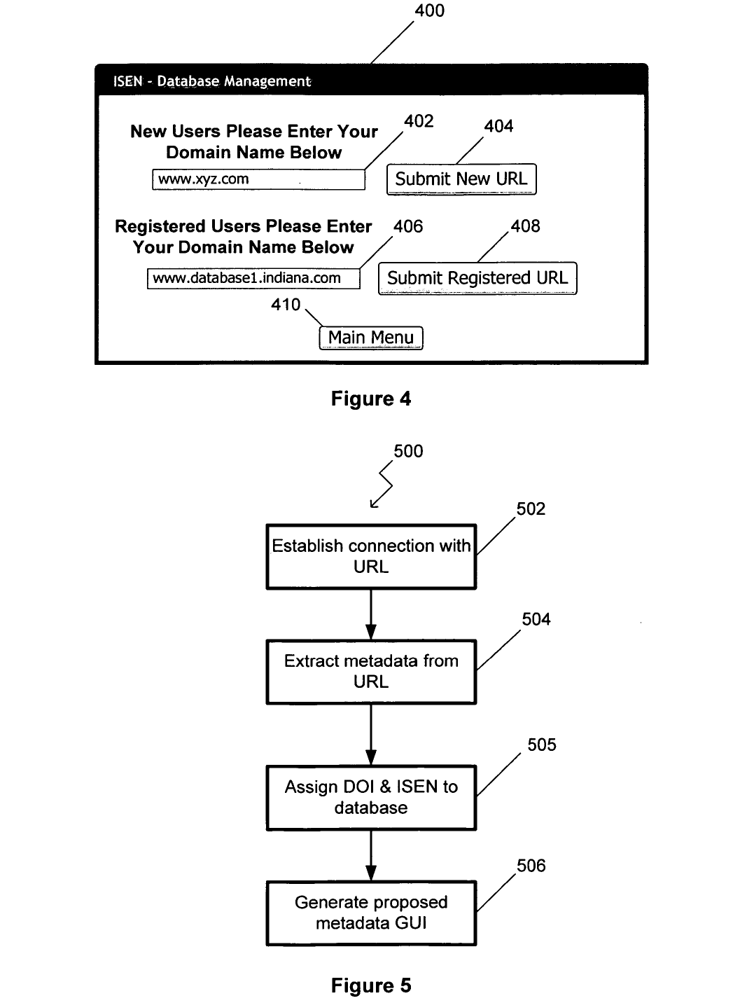

Referring to FIG. 4, selection of the database account command button 302 in the main GUI 300 may generate an ISEN database management GUI 400. The ISEN database management GUI 400 may be operable to easily allow owners of proprietary databases 114 to register these respective proprietary databases 114 with the ISEN system 100 as well as to allow registered users to edit respective data records associated with the proprietary databases 114. The ISEN database management GUI 400 may include a new URL entry field 402 that allows users to enter a new domain name or URL to be added to the ISEN database 116. When a user or database owner wants to add or register a proprietary database 114 to the ISEN system 100, they will enter a URL that is assigned to or associated with the proprietary database 114 into the URL entry field 402.

After entry of the URL, selection of a submit new URL command button 404 may cause the ISEN software application 104 to automatically generate a proposed ISEN metadata record that is associated with the proprietary database 114 located at or stored at the URL. The ISEN database management GUI 400 may also include a registered ISEN URL entry field 406 that allows users who have previously registered a respective proprietary database 114 in the ISEN system 100 to pull up a respective metadata record associated with a given URL that may be stored in the ISEN database 116. The database owner may then be allowed to edit the metadata record as set forth below. A proposed metadata software module may generate the proposed metadata record. The ISEN database management GUI 400 may also include a main menu command button 410 that may return the user to the main GUI 300.

Referring to FIG. 5, the database account module 202 may include a metadata record creation module 500 that may be operable to automatically extract metadata from the URL and create a proposed metadata record associated with the URL that is entered in the new URL entry field 402. Upon selection of the submit new URL command button 404, the automatic metadata record creation module 500 may automatically establish a connection with the URL entered in the new URL entry field 402, which is illustrated at step 502.

After the connection is established with the URL, the metadata record creation module 500 may automatically extract metadata associated with the URL from the designated URL, which is illustrated at step 504. The metadata record creation module 500 may create the proposed metadata record by reading the content of an hypertext markup language (“HTML”) meta tag or a title field in a media file located on the proprietary database 114 via the URL. As known in the art, a meta tag is an HTML tag that identifies the contents of a web page. Meta tags are hidden on the web page, but they, as well as all the HTML code on a page, may typically be viewed by selecting View/Source or View/Page Source from a browser menu. The metadata record creation module 500 is operable to read metadata that may be associated with any given URL in any file format (e.g. html, asp, etc.). As known in the art, meta tags may contain a general description of the web page, keywords and copyright information.

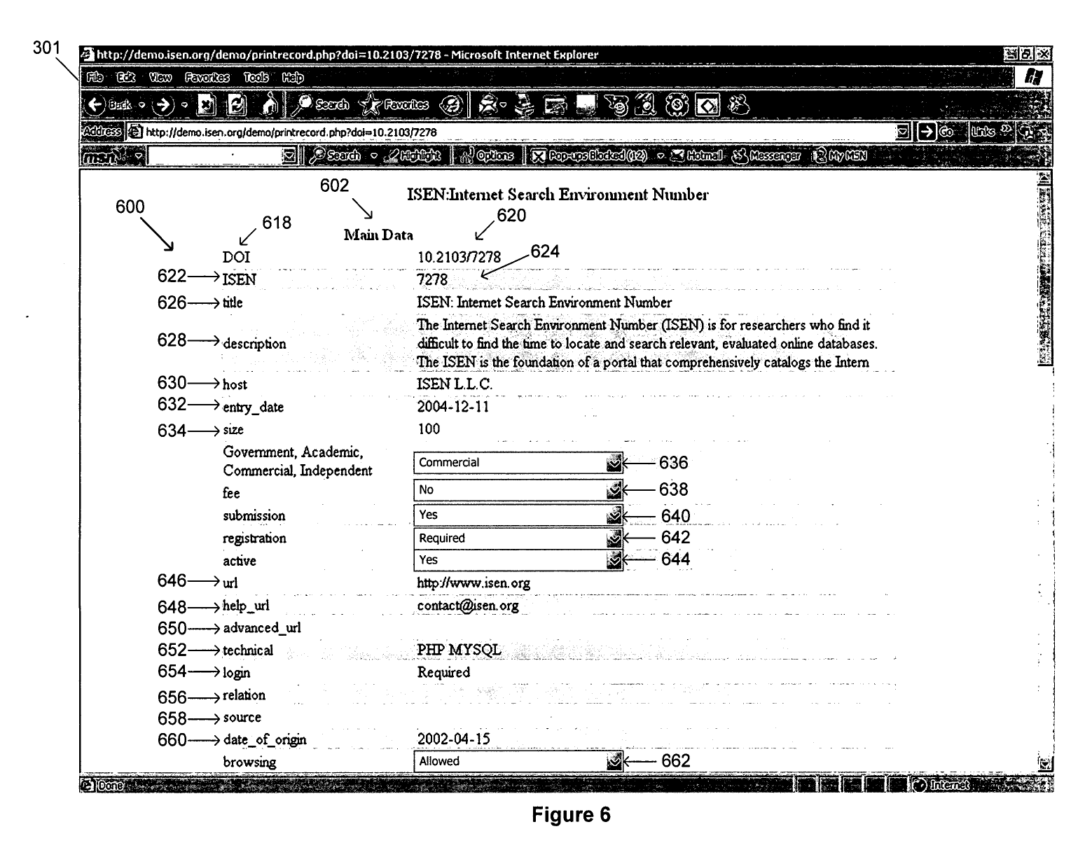

As set forth in greater detail below, the metadata record creation module 500 may assign a unique digital object identifier (“DOI”) and an ISEN to the proprietary database 114, which is illustrated at step 505. The DOI and ISEN provide a persistent, unique identification to the proprietary database 114 and, as set forth below, may be stored on the web page at the URL, may be stored on the ISEN database 116, and may also be stored at a host location in a database. At step 506, a proposed metadata module of the metadata record creation module 500 may generate a proposed metadata record, which is discussed in greater detail in regards to FIGS. 6-9, and display it in browser 301 on the respective database owner's computer 110.

Referring to FIGS. 6-9, an illustrative proposed metadata record 600 that may be generated by the metadata record creation module 500 is depicted in browser 301. The metadata record creation module 500 may automatically place metadata found at a respective web page associated with the URL into a plurality of categories. The categories may include a main data category 602, a contact category 604, a language category 606, a database type category 608, a coverage category 610, a keyword category 612, a rights management category 614, and an IP subnet category 616. As set forth in greater detail below, each of these categories 602-616 contains various data values or text entries that may be automatically populated by the metadata record creation module 500. The data values are related to and describe the contents of the proprietary database 114 that is associated with the URL entered in the new URL entry field 402.

The main data category 602 may include a digital object identifier (“DOI”) 618 that includes a unique DOI 620 that is automatically generated and assigned to the URL by the automatic metadata creation software module 500. The DOI 620 is used by the ISEN system 100 to provide a persistent, unique identification number for digital data content stored in respective proprietary databases 114 that are registered with the ISEN system 100. The DOI 620 used by the ISEN system 100 may consist of two components: 1) a publisher prefix that uniquely identifies ISEN as a database registrar (e.g.—10.2103), and 2) an ISEN (e.g.—7278 or abv3ghij), which is a persistent, unique identifier that is associated with the respective digital content being submitted for inclusion in the ISEN system 100. As such, the DOI 620 in our example above and in FIG. 6 appears as: 10.2103/7278. The ISEN is an alphanumeric universal unique identifier (“UUID”) that may be automatically assigned to each respective database 114 registered with the ISEN system 100.

The metadata record 600 may also include an ISEN field 622 that may include an ISEN 624. As set forth above, the ISEN 624 is used to associate a unique and persistent identifier to the respective data content that is being submitted for inclusion in the ISEN system 100. Publishers or database owners may have more than one proprietary database 114 that they may want included in the ISEN system 100 and the ISEN 624 allows publishers and/or proprietary database owners to submit, register, and store metadata records for multiple databases 114 into the ISEN system 100. Each respective database submission may have its own ISEN 624 assigned to the respective database 114 under the publisher prefix, thereby forming the DOI 620. For example, if a particular proprietary database owner has two separate URLs that they want to register with the ISEN system 100, the ISEN system 100 is operable to assign a respective ISEN 624 to each respective database 114. The ISEN 624 and the publisher prefix thereby forming respective DOIs 620 for the databases 114 (e.g.—first database—10.2103/7278, second database—10.2103/7279 and so forth).

As set forth above, the metadata record creation module 500 may automatically create and assign the ISEN 624 and the DOI 620, which includes the ISEN 624, to each respective proprietary database 114 registered with the ISEN system 100. Proprietary database 114 should be construed herein to include or be capable of storing a wide array of digital media types, such as text, graphics, sound, video and so forth. The metadata record 600 may then be stored in the ISEN database 116 and, as set forth below, when users are using the ISEN system 100 to search for data about a particular subject, the ISEN system 100 may use the ISEN 624 to resolve or send the user to the data contained in a respective proprietary database 114. These fields 620, 624 typically are not editable by the owner of the proprietary database 114, but may be edited by an ISEN operator or cataloger.

The main data category 602 may also include a title field 626 and a description field 628. The text displayed in these respective data fields 626, 628 may be edited by the owner of the proprietary database 114, but are preferentially initially generated by the metadata record creation module 500. The title field 626 may display the title of the data that is stored in the proprietary database 114. The description field 626 may set forth a brief description or summary of the data that is stored in the proprietary database 114. If not automatically populated by the metadata record creation module 500 or if the user does not feel that the automatically populated title and brief summary accurately reflects the nature of the data, a user may edit the text contained in these respective fields 626, 628.

The metadata record 600 may also include a host field 630, an entry date field 632, and a size field 634. The host field 630 is used to display the name of the entity that owns the data contained in the proprietary database 114 or the name of the entity hosting, as that term is used in the art, the proprietary database 114. The entry date field 632 is used to indicate the date in which the proprietary database 114 was registered with the ISEN system 100. The size field 634 is used to indicate the size of the proprietary database 114, which may be displayed in megabytes for example. The size field 634 could also be used to indicate the number of records or documents contained in the proprietary database 114. For the sake of brevity, it should be noted that some fields of the metadata record 600 may be modified by the owner of the proprietary database 114 and some may not. For example, the entry date display field 634 may not be edited by the owner in some embodiments.

An entity type drop down list or field 636 may be included that allows the owner to select the type of entity the host indicated in the host display field 630 qualifies as. Again, this may be automatically populated by the metadata record creation software module 500, but may be edited by the owner of the database 114. For example, selection of the entity type selection drop down list 636 may cause the metadata record creation module 500 to generate a list of respective entity types (e.g.—government, commercial, academic, independent, and so forth). Those skilled in the art would recognize that drop down lists and various other types of data entry and selection mechanisms may be used in the present invention. The entity type drop down list 636 may also comprise a text box that may be edited by the owner.

The metadata record 600 may also include a fee indication drop down list 638, a submission indication drop down list 640, a registration requirement drop down list 642, and an active drop down list 644. The fee indication drop down list 638 may be used to indicate whether or not there are any charges associated with accessing the data stored in the proprietary database 114. The submission indication drop down list 640 may be used to indicate whether or not the owner of the proprietary database 114 accepts submissions of data relating to the data stored in the proprietary database 114. The registration requirement drop down list 642 may be used to indicate whether or not independent third-party users need to register with the owner of the proprietary database 114 before being provided access to the data stored in the proprietary database 114. The active drop down list 644 may include an indication on whether or not the data is accessible at any given time period.

A URL display field 646 may be included that allows the owner of the proprietary database 114 to indicate the primary URL location of the data contained in the proprietary database 114. A help contact field 648 may be included for displaying a URL or contact address for persons seeking help concerning the data. An advanced URL 650 may be included for cataloging an advanced search mode of the web page located at the URL or to indicate the location of the ISEN advanced search page, which is set forth in detail below. A database type field 652 may be included for indicating the database format. A login field 654 may be included for indicating whether or not an independent third-party is required to login in order to gain access to the data stored on the proprietary database 114.

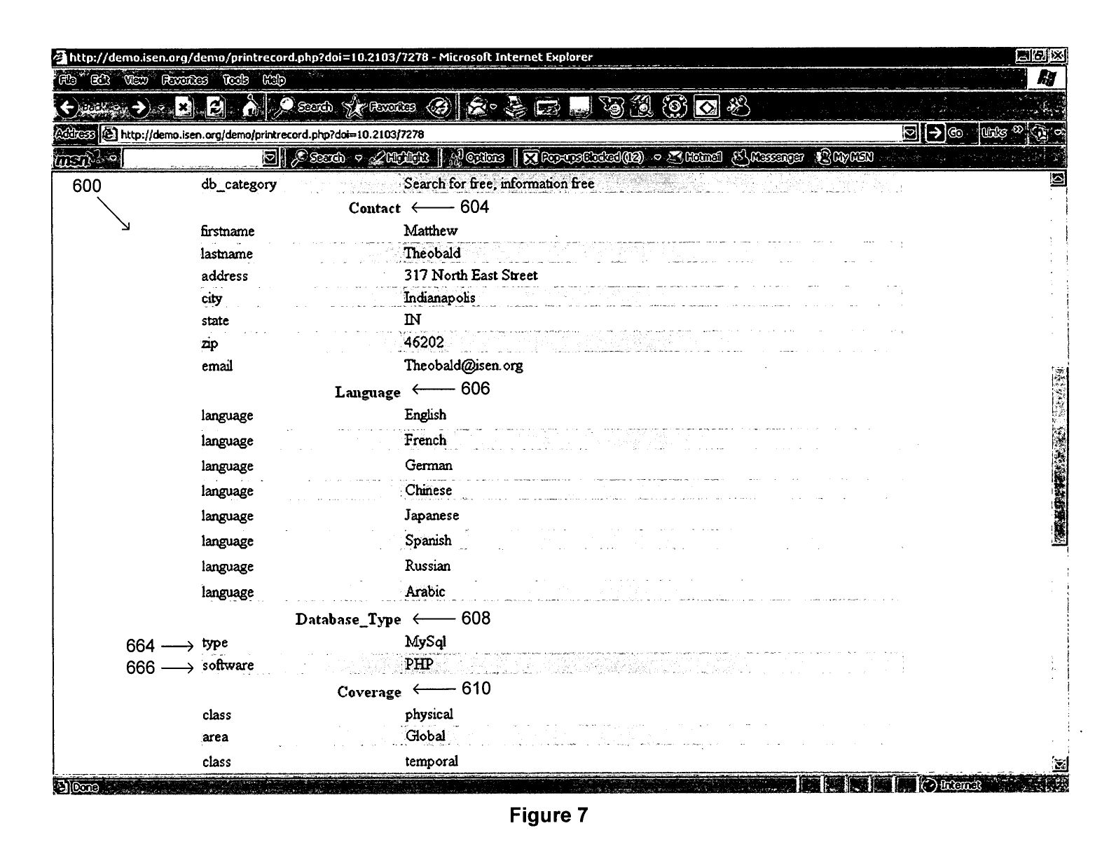

A relation field 656 may be included for designating resources related to the proprietary database 114. A source field 658 may be included for designating a reference to a resource from which the present resource is derived. A date of origin field 660 may be included for displaying the date in which the data that is stored in the proprietary database 114 was created or copyrighted. In addition, a browsing field 662 may be included for indicating whether or not users are allowed the browse or view the data, but not copy the data. Referring to FIG. 7, the metadata record 600 may also include a database category field 664 for indicating whether or not any or all of the data contained in the proprietary database 114 may be browsed for free or for a cost and may also indicate the cost associated therewith.

As further illustrated in FIG. 7, the contact category 604 may include display fields that provide information needed to contact the owner of the proprietary database 114. The contact category 604 may include additional information fields not illustrated in FIG. 7 such as a telephone number, a facsimile number and so forth. For the sake of brevity, a detailed discussion of the information fields provided in the contact category 604 has been omitted as those skilled in the art would clearly recognize the type information that may be included in this respective category 604. For the purpose of the present invention, it is important to note that the metadata record 600 may include this information and it may be edited by the owner of the proprietary database 114.

As previously set forth, the metadata record 600 may also include a language category 606. As illustrated, the language category 606 may be used to display the languages in which the data that is stored in the proprietary database 114 is available to end users. The database type category 608 may include a database type field 664 and a database software field 666. The database type field 664 may include an indication of the type of database in which the data is stored. The database software field 666 may set forth the type of software that was used to create and store data contained in the proprietary database 114. As previously set forth, the fields 664, 666 may be edited by the owner of the proprietary database 114 to properly indicate or set forth the relevant information contained in the fields 664, 666.

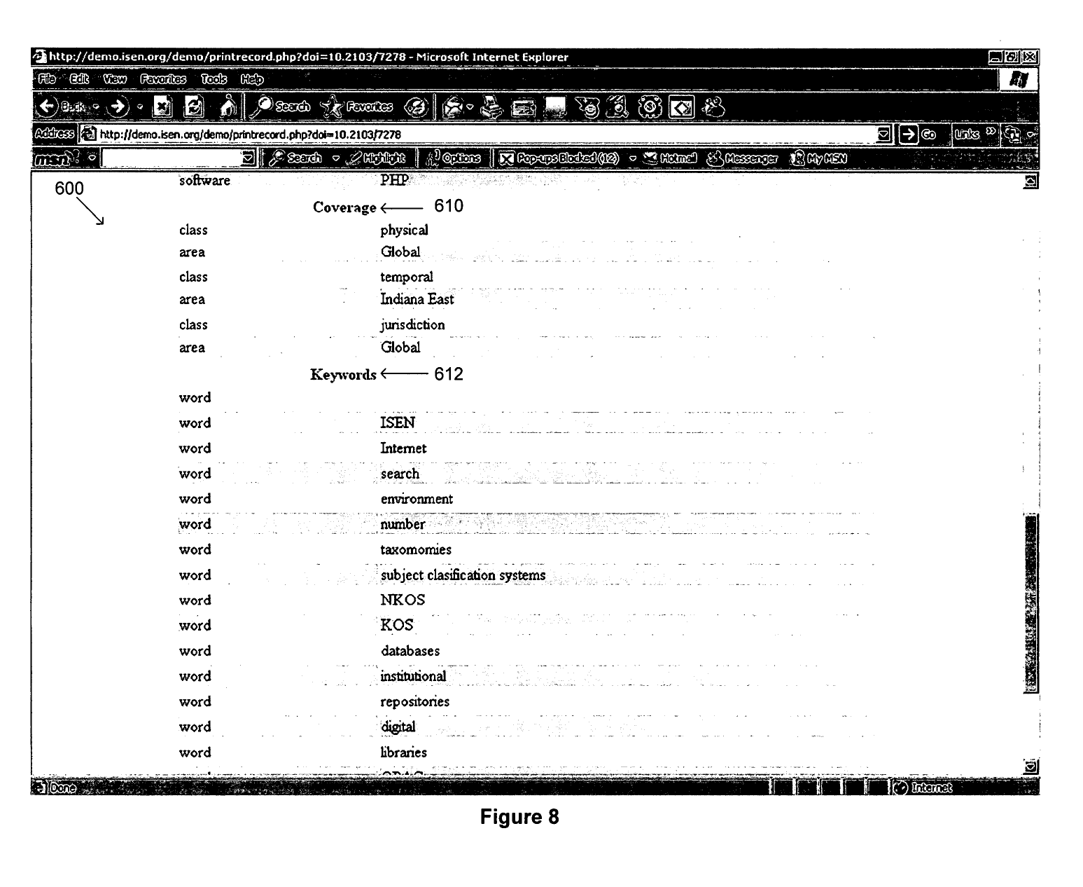

Referring to FIGS. 7 and 8, the coverage category 610 relates to time and place. For example, the coverage category 610 may contain text entries relating to the physical time zone that the proprietary database 114 is physically located. In addition, the coverage category 610 may contain entries relating to the geographic location or range that the subject matter contained in the proprietary database 114 is related to (e.g.—Indiana, Midwest, U.S., North America, etc.). In addition, the coverage category 610 may include text entries related to the time range that the proprietary database 114 covers (e.g.—1970-2005). Further, although not illustrated, the coverage category 610 may include contact information for contacting a predetermined person associated with the proprietary database (e.g.—name, phone number, email address, etc.).

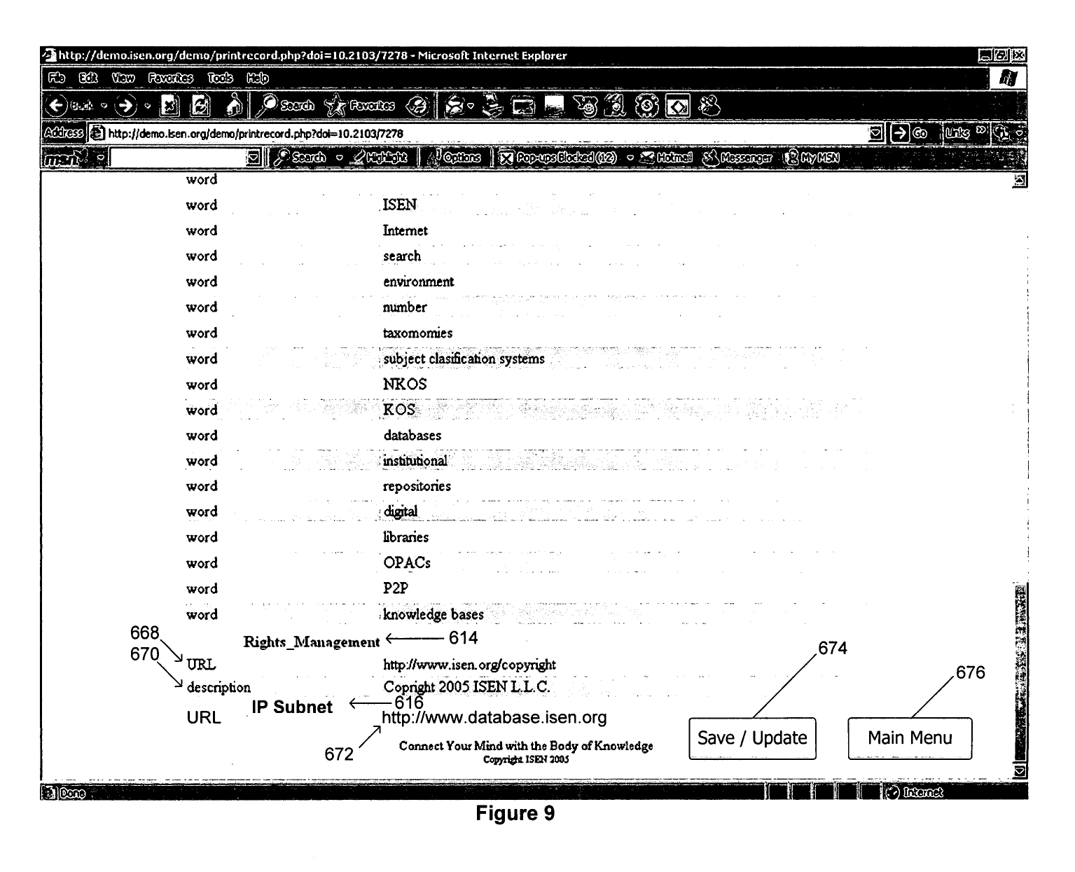

As illustrated in FIGS. 8 and 9, the keywords category 612 may include a plurality of display fields that may be automatically generated or populated by the metadata record creation module 500. As known in the art, metadata or meta tags that are associated with URLs often include several keywords that are associated with or related to the content of the website. The metadata record creation module 500 is operable to extract this data and populate keyword data fields under the keywords category 614. As previously set forth, the data contained in the display fields under the keywords category 612 may be edited by the owner of the proprietary database 114 to properly indicate or set forth the relevant information contained in the fields.

As illustrated in FIG. 9, the metadata record may also include the rights management category 614. The rights management category 614 may include a legal URL field 668 and a legal description field 670. The legal URL field 668 may set forth the URL for a legal description of the data contained in the proprietary database 114. The legal description field 670 may be used to display a legal notice regarding ownership of the data. Those skilled in the art would recognize that other display fields may also be included under the rights management category 614. The IP subnet category 616 may include an IP subnet URL listing field 672. The IP subnet URL listing field 672 may set forth alternative or segmented URLs in which the data may be located.

A save or update command button 674 may be provided at the end of the metadata record 600. Selection of the save or update command button 674 causes the metadata record 600 to automatically be sent to the ISEN system 100 to be reviewed by a cataloger. As set forth in greater detail below, the cataloger at ISEN will review the metadata record 600 and may make changes to the metadata record 600 in much the same fashion as set forth above. Once reviewed by a cataloger, the owner of the proprietary database 114 may be contacted by the cataloger to review any changes made. A main menu command button 676 may also be provided for returning the user to the main GUI 300.

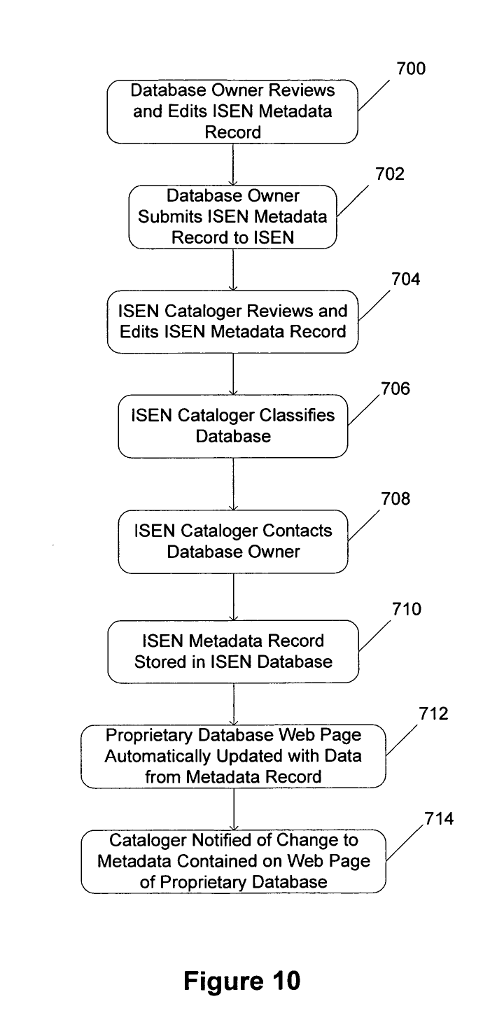

Referring to FIG. 10, the process of creating an ISEN metadata record 600 for inclusion in the ISEN database 116 is depicted. At step 700, as set forth above, the owner of the proprietary database 114 is presented with a proposed metadata record 600. The owner is allowed to review and edit various or select data values contained in the metadata record 600 that are associated with the proprietary database 114. Once the database owner is finished editing the metadata record 600, selection of the save or update command button 674 causes the metadata record creation module 500 to automatically transmit the proposed metadata record 600 to the ISEN server 102 of the ISEN system 100, which is represented at step 702. ISEN cataloging staff, which are preferentially professionally trained librarians, are then able to review and edit, if necessary, the ISEN metadata record 600. A cataloger proposed metadata record module 704 may generate a GUI on a computer being used by the cataloger that allows the cataloger to review and edit the proposed metadata record 600. As set forth above in greater detail, the catalogers at ISEN will review and edit the proposed metadata record 600 in a manner similar to that described in relation to FIGS. 6-9.

After the ISEN cataloger has finished reviewing and editing the proposed metadata record 600, the ISEN cataloger may classify the proprietary database 114, which is represented at step 706. The proprietary databases 114 may be classified according to the Library of Congress classification scheme, which may be modified somewhat by ISEN to accommodate the varying forms of data that may be found on the Internet. For a detailed discussion of the Library of Congress classification scheme, please refer to http://www.loc.gov/catdir/cpso/lcco/lcco.html. In general terms, the classification scheme used may be broken down by varying subject categories such as, for example: A—GENERAL WORKS; B—PHILOSOPHY. PSYCHOLOGY. RELIGION; C—AUXILIARY SCIENCES OF HISTORY; D—HISTORY (GENERAL) AND HISTORY OF EUROPE; E—HISTORY: AMERICA; F—HISTORY: AMERICA; G—GEOGRAPHY. ANTHROPOLOGY. RECREATION; H—SOCIAL SCIENCES; J—POLITICAL SCIENCE; K—LAW; L—EDUCATION; M—MUSIC AND BOOKS ON MUSIC; N—FINE ARTS; P—LANGUAGE AND LITERATURE; Q—SCIENCE; R—MEDICINE; S—AGRICULTURE; T—TECHNOLOGY; U—MILITARY SCIENCE; V—NAVAL SCIENCE; Z—BIBLIOGRAPHY. LIBRARY SCIENCE. INFORMATION RESOURCES (GENERAL).

Under each one of the respective broad categories may be more general categories. For example, under the A—General Works category, the following sub-categories may be used:

| | |
|---|---|
| Subclass AC | |
| AC1-999 | Collections. Series. Collected works |
| AC1-195 | Collections of monographs, essays, etc. |
| AC1-8 | American and English |
| AC9-195 | Other languages |
| AC200 | Collections for Jewish readers |
| AC801-895 | Inaugural and program dissertations |
| AC901-995 | Pamphlet collections |
| AC999 | Scrapbooks |
| Subclass AE | |
| AE1-(90) | Encyclopedias |
| AE5-(90) | By language |

After the cataloger has reviewed the proposed metadata record 600 and classified the proprietary database 114, the cataloger may contact the owner of the proprietary database 114 to review or go over the proposed metadata record 600 with the owner, which is illustrated at step 708. The cataloger may contact the owner via telephone or email. If the editor/cataloger contacts the owner by email, the proposed metadata record 600 may be sent as an attachment to the email message and may provide information on how to contact the cataloger. The purpose of contacting the owner of the proprietary database 114 is to review or go over any changes made to the proposed metadata record 600 by the cataloger before the proposed metadata record 600 is placed in final form and stored in the ISEN database 116.

Once the cataloger and database owner have communicated and each party is satisfied with the data content contained in the metadata record 600, the cataloger may save the metadata record 600 in the ISEN database 116 as a final metadata record, which is represented at step 710. As further illustrated at step 712, the data content or metadata contained in the final metadata record 600 may also automatically be propagated to the web page located on the URL associated with the final metadata record 600. As such, the web page associated with the proprietary database 114 will contain metadata that matches or reflects the data contained in the final metadata record 600. If the owner of the proprietary database 114 makes a change to the metadata contained in the web page associated with the proprietary database 114, a message may automatically be generated and sent to the cataloger, which is represented at step 714. The process may then begin back at step 704.

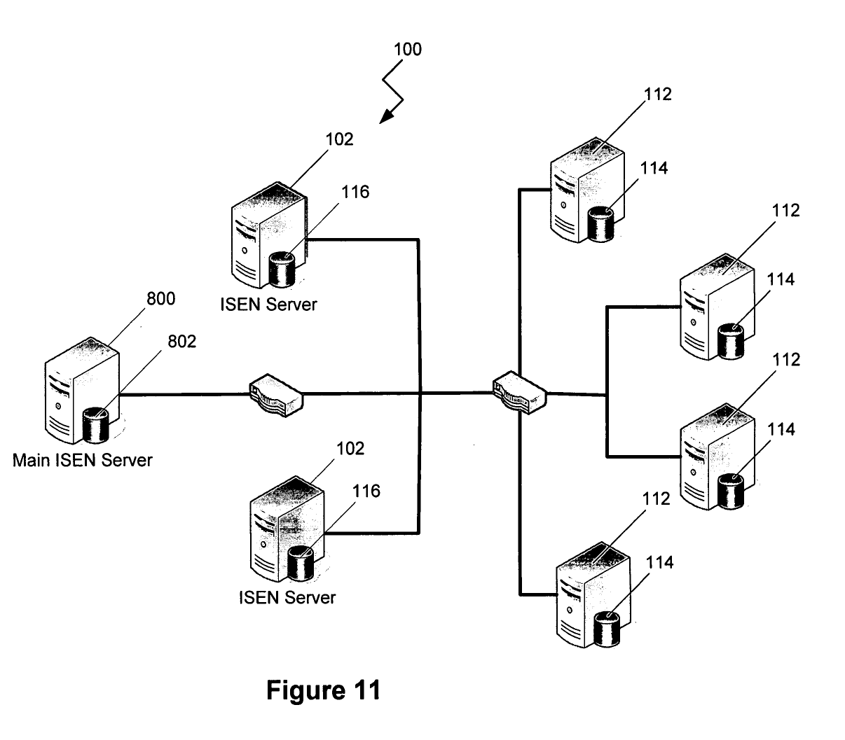

Referring to FIG. 11, in another embodiment of the present invention, once the ISEN system 100 grows in popularity a plurality of ISEN servers 102 may be located at various geographic locations. The metadata records 600 for various proprietary databases 114 may be stored in each ISEN database 116. However, in this embodiment, a main ISEN server 800 may be used to store a “master” copy of each metadata record 600 used by the ISEN system 100. As such, each metadata record 600 may be stored in a main ISEN database 802 associated with or located on the main ISEN server 800.

As set forth above, in this embodiment of the present invention, the master copy of the ISEN metadata record 600 associated with each proprietary database 114 resides in the main ISEN database 802. Any changes made to the metadata records 600 stored in the main ISEN database 802 are automatically propagated to copies of the metadata records 600 store in the ISEN databases 116 associated with various ISEN servers 102. In addition, the data content contained in the metadata record 600 may also be propagated to the web page located on the URL associated with the metadata record 600. As such, the web page associated with the proprietary database 114 will contain metadata that matches or reflects the data contained in the metadata record 600. Really Simple Syndication (“RSS”) may be used to maintain accurate and identical copies of the metadata records 600 in the ISEN databases 116 and the web page where the proprietary database 114 is located. If, instead, a change is made to either of the copies other than the master metadata record 600 stored in the main ISEN database 802, the change will not propagate. Instead, as set forth above, the ISEN cataloger will be automatically notified, preferentially via email, about the changed copy and will take any action needed.

Referring to FIGS. 2, 3 and 12, the ISEN system 100 may also include a search software module 204. Selection of the search command button 304 may cause the ISEN software application 104 to generate a quick search GUI 900. The quick search GUI 900 may include a search term entry field 902, a search command button 904 and a cancel command button 906. The search term entry field 902 allows a researcher to enter at least one term to be searched across the ISEN database 116. Once at least one search term is entered, selection of the search command button 904 automatically causes the ISEN software application 104 to search the ISEN database 116 for matching terms. In one embodiment of the present invention, the ISEN software application 104 will search the metadata records 600 for matching terms. In particular, the ISEN software application may search the title fields 626, the description fields 628, and the keywords 612 of the metadata records 600. Selection of the cancel command button 904 may cause the ISEN software application 104 to terminate the search.

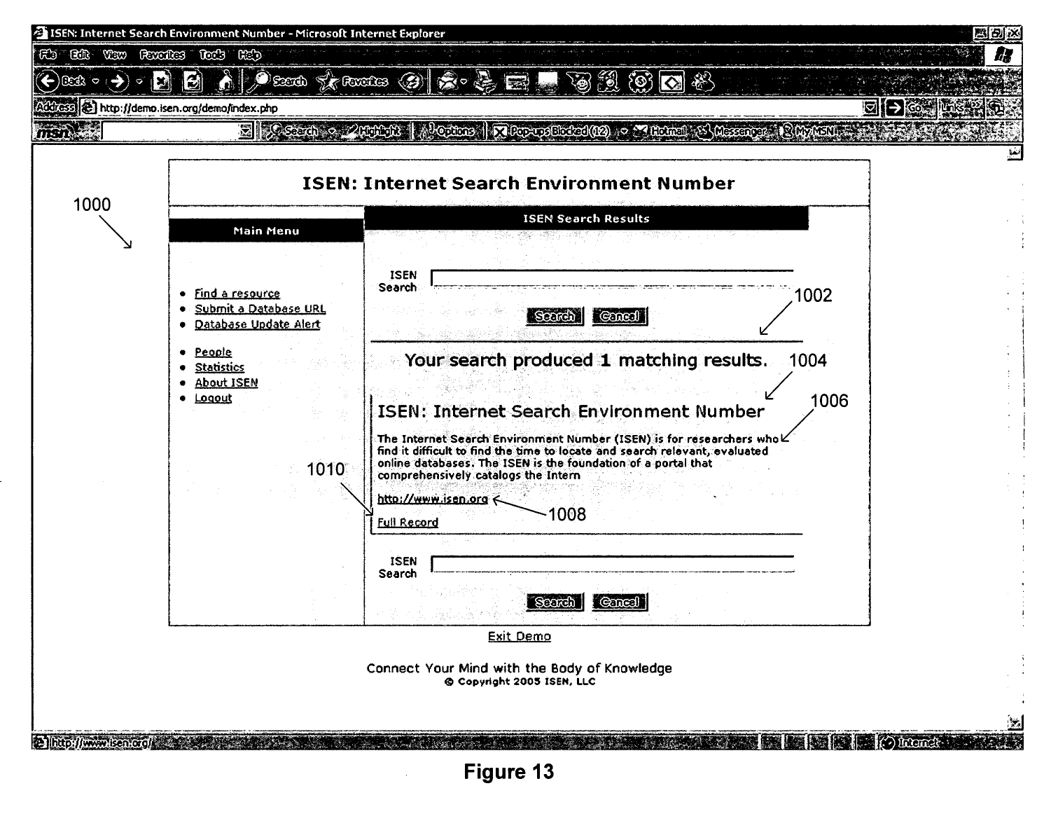

Referring to FIG. 13, a search result GUI 1000 may be generated in response to a search entered by a user in the search term entry field 902 and selection of the search command button 904. As illustrated, the search result GUI 1000 may include a search results display field 1002 that displays a summary of the matching results of the search. The search results display field 1002 may include a title display field 1004, a description display field 1006, a URL hyperlink 1008, and a full record hyperlink 1010 for each respective matching search result. The title display field 1004 for the matching search result may correspond to the title field 626 of the metadata record 600 associated with the proprietary database 114. The description display field 1006 may correspond to the description field 628 associated with the metadata record 600 for that particular proprietary database 114. The URL hyperlink 1008 is provided to provide a quick jump point to the web page associated with the proprietary database 114 located by the search. The full record hyperlink 1010 will pull up the metadata record 600 associated with the search result.

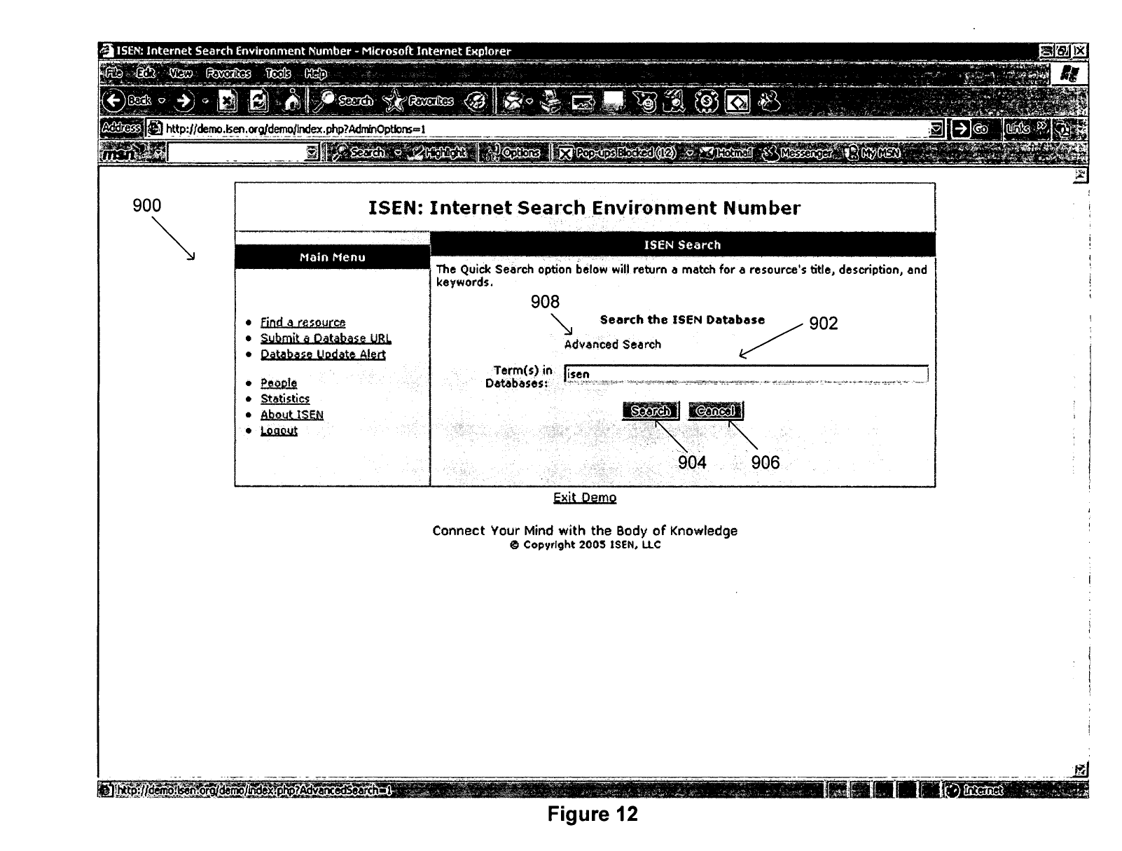

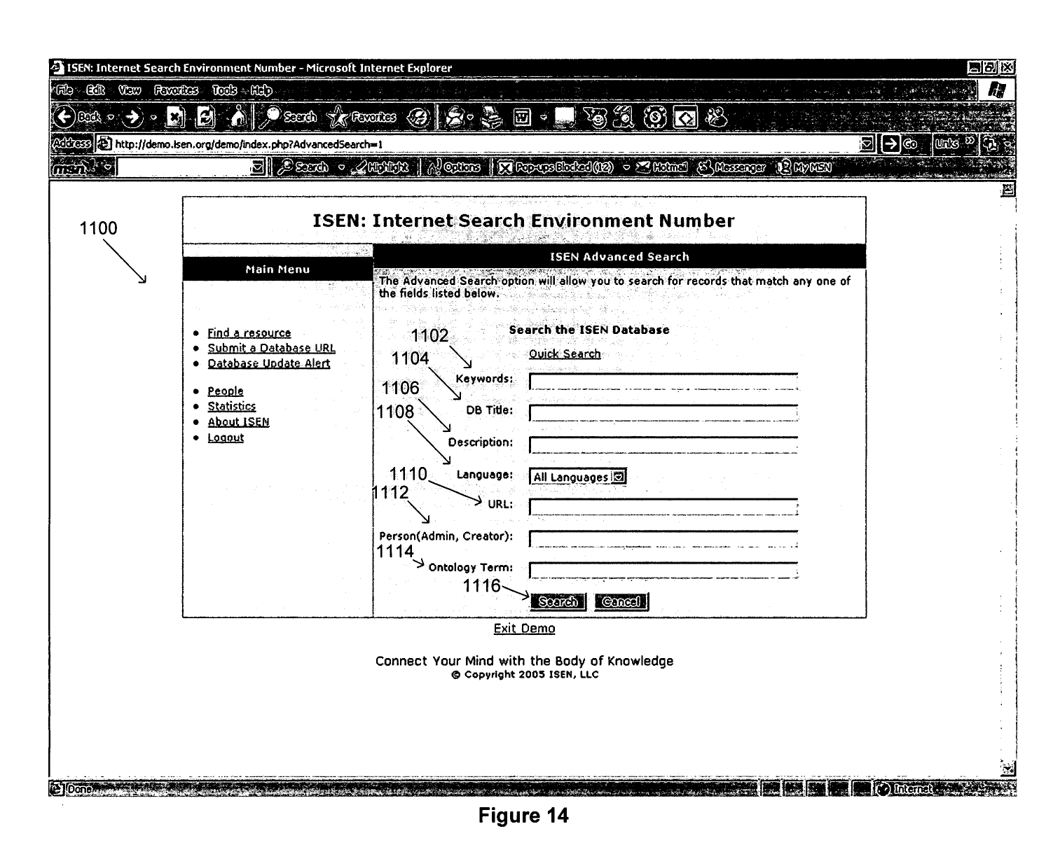

Referring to FIGS. 12 and 14, the quick search GUI 900 may also include an advanced search hyperlink 908. Selection of the advanced search hyperlink 908 may cause the ISEN software application 104 to generate an advanced search GUI 1100. The advanced search GUI 1100 may include a plurality of data entry fields 1102-1114 that allow a researcher to search for data stored in the proprietary databases 114 that is associated with any given subject. The advanced search GUI 1100 may include a keyword(s) entry field 1102, a database title entry field 1104, a description entry field 1106, a language entry field 1108, a URL entry field 1110, a person entry field 1112, and an ontology entry field 1114. The researcher may enter one or more words, or designate a particular language, in each of these fields 1102-1114 and search the metadata records 600 stored in the ISEN database 116 for matches.

The keyword(s) entry field 1102 allows a researcher to enter one or more designated words for the search module 204 to search the metadata records 600 stored in the ISEN server 102. In particular, the search module 204 may search the keywords located under the keywords category 612 of each metadata record 600 stored in the ISEN server 102 for matches for the words entered in the keyword(s) entry field 1102. The database title entry field 1104 allows a researcher to enter one or more designated words for the search module 204 to search the metadata records 600 stored in the ISEN server 102. The search module 204 may search the title field 626 of each metadata record 600 stored in the ISEN server 102 for matches for the words entered in the database title entry field 1104.

The description entry field 1106 allows a researcher to enter one or more designated words for the search module 204 to search the description fields 628 of the metadata records 600. The language entry field 1108 allows the user to select or designate a particular language to search. The URL entry field 1110 allows the researcher to enter a URL to search for in the metadata records 600. The person entry field 1112 allows the researcher to enter the name of an individual to search for in the metadata records 600. The ontology term entry field 1114 allows the researcher to enter an ontology term to search for in the metadata records 600. Selection of a search command button 1116 causes the search module 204 to conduct the search for the terms provided. The results of the search may be displayed in a search result GUI 1000 similar to that set forth in FIG. 13.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. An Internet search environment number system, comprising:
a proprietary database operable to connect with an Internet search environment number server;
a metadata record creation module operable to allow a proprietary database owner to enter a designated universal resource locator assigned to said proprietary database, wherein said metadata record creation module is operable to establish a connection with at least one web based file located at said universal resource locator, wherein said metadata record creation module is operable to extract metadata from said at least one web based file, wherein said metadata record creation module is operable to automatically generate a proposed metadata record associated with said proprietary database, wherein said proposed metadata record includes an Internet search environment number that comprises a unique and persistent identifier that is automatically assigned to said proprietary database;
a proposed metadata module operable to generate a proposed metadata record as a function of metadata extracted from said at least one web based file and generate a graphical user interface that presents said proposed metadata record to said proprietary database owner, wherein said proposed metadata module allows said proprietary database owner to review and edit select portions of said proposed metadata record, wherein said proposed metadata module is further operable to allow said proprietary database owner to submit said proposed metadata record to said Internet search environment number server;
a cataloger notification module for notifying a cataloger of receipt of said proposed metadata record; and
a cataloger metadata module operable to allow a cataloger to review and edit said proposed metadata record after receipt by said Internet search environment number server, wherein said cataloger may contact said proprietary database owner to review said proposed metadata record, wherein said proposed metadata record is stored in an Internet search environment number database associated with said Internet search environment number server as a final metadata record after said cataloger and said proprietary database owner have reviewed and edited said proposed metadata record.

2. The Internet search environment number system of claim 1, wherein said proposed metadata record includes a main data category, a contact category, a language category, a database type category, a coverage category, a keyword category, a rights management category, and an IP subnet category.

3. The Internet search environment number system of claim 2, wherein said main data category includes a digital object identifier that is automatically assigned to said proprietary database, wherein said digital object identifier includes a prefix identifier and a suffix identifier.

4. The Internet search environment number system of claim 3, wherein said prefix identifier comprises a publisher prefix.

5. The Internet search environment number system of claim 4, wherein said publisher prefix comprises a unique identifier assigned to a registrar of databases.

6. The Internet search environment number system of claim 3, wherein said Internet search environment number comprises said suffix identifier.

7. The Internet search environment number system of claim 2, wherein said main data category includes a digital object identifier, a Internet search environment number, a title field, a description field, a host field, an entry date field, a database size field, an entity type field, a fee indication field, a submission indication field, a registration requirement field, an active field, a universal resource locator field, a help contact field, an advanced universal resource locator field, a login field, a relation field, a source field, a date of origin field, a browsing field and a database category field, wherein said contact category may include a plurality of contact data fields for contacting said proprietary database owner, wherein said language category includes a plurality of language fields for designating a list of languages in which said proprietary database is available, wherein said database type category includes a database type field and a database software field, wherein said coverage category includes a plurality of geographic and time orientation fields, wherein said keyword category includes a plurality of keywords associated with said proprietary database, wherein said rights management category includes a legal universal resource locator field and a legal description field, wherein said IP subnet category includes a IP subnet universal resource listing field.

8. An Internet search environment number system, comprising:
computer readable program code for allowing a proprietary database owner to submit a universal resource locator assigned to a proprietary database;
computer readable program code for establishing a connection with at least one web page designated by said universal resource locator;
computer readable program code for automatically extracting metadata from said web page designated by said universal resource locator;
computer readable program code for automatically generating a proposed metadata record associated with said proprietary database located at said universal resource locator, wherein said proposed metadata record includes an Internet search environment number that comprises a unique and persistent identifier that is automatically assigned to said proprietary database;
computer readable program code for presenting said proposed metadata record to said proprietary database owner;
computer readable program code for allowing said proprietary database owner to review and edit select portions of said proposed metadata record;
computer readable program code for allowing said proprietary database owner to submit said proposed metadata record to an Internet search environment number server;
computer readable program code for notifying a cataloger associated with said Internet search environment number server of receipt of said proposed metadata record;
computer readable program code for allowing said cataloger to review and edit said proposed metadata record to create a final metadata record;
computer readable program code for allowing said cataloger to transmit said final metadata record to said proprietary database owner;
computer readable program code for storing said final metadata record in a metadata record database; and
computer readable program code for modifying said web page located at said universal resource locator to include metadata contained in said final metadata record.

9. The Internet search environment number system of claim 8, wherein said proposed metadata record includes a main data category, a contact category, a language category, a database type category, a coverage category, a keyword category, a rights management category, and an IP subnet category.

10. The Internet search environment number system of claim 9, wherein said main data category includes a digital object identifier that is automatically assigned to said proprietary database, wherein said digital object identifier includes a prefix identifier and a suffix identifier.

11. The Internet search environment number system of claim 10, wherein said prefix identifier comprises a publisher prefix.

12. The Internet search environment number system of claim 11, wherein said publisher prefix comprises a unique identifier assigned to a registrar of databases.

13. The Internet search environment number system of claim 10, wherein said Internet search environment number comprises said suffix identifier.

14. The Internet search environment number system of claim 9, wherein said main data category includes a digital object identifier, a Internet search environment number, a title field, a description field, a host field, an entry date field, a database size field, an entity type field, a fee indication field, a submission indication field, a registration requirement field, an active field, a universal resource locator field, a help contact field, an advanced universal resource locator field, a login field, a relation field, a source field, a date of origin field, a browsing field and a database category field, wherein said contact category may include a plurality of contact data fields for contacting said proprietary database owner, wherein said language category includes a plurality of language fields for designating a list of languages in which said proprietary database is available, wherein said database type category includes a database type field and a database software field, wherein said coverage category includes a plurality of geographic and time orientation fields, wherein said keyword category includes a plurality of keywords associated with said proprietary database, wherein said rights management category includes a legal universal resource locator field and a legal description field, wherein said IP subnet category includes a IP subnet universal resource listing field.

15. A method of generating an Internet search environment number for uniquely identifying databases published on the Internet, comprising the steps of:
allowing a proprietary database owner to submit a universal resource locator assigned to a proprietary database;
establishing a connection with at least one web page designated by said universal resource locator;
extracting metadata from said at least one web page;
generating a proposed metadata record associated with said proprietary database, wherein said proposed metadata record includes a main data category, a contact category, a language category, a database type category, a coverage category, a keyword category, a rights management category, and an IP subnet category, wherein said main data category includes a digital object identifier, a Internet search environment number, a title field, a description field, a host field, an entry date field, a database size field, an entity type field, a fee indication field, a submission indication field, a registration requirement field, an active field, a universal resource locator field, a help contact field, an advanced universal resource locator field, a login field, a relation field, a source field, a date of origin field, a browsing field and a database category field, wherein said contact category may include a plurality of contact data fields for contacting said proprietary database owner, wherein said language category includes a plurality of language fields for designating a list of languages in which said proprietary database is available, wherein said database type category includes a database type field and a database software field, wherein said coverage category includes a plurality of geographic and time orientation fields, wherein said keyword category includes a plurality of keywords associated with said proprietary database, wherein said rights management category includes a legal universal resource locator field and a legal description field, wherein said IP subnet category includes a IP subnet universal resource listing field;
presenting said proposed metadata record to said proprietary database owner;
allowing said proprietary database owner to review and edit select portions of said proposed metadata record;
allowing said proprietary database owner to submit said proposed metadata record to an Internet search environment number server;
notifying a cataloger of receipt of said proposed metadata record;
allowing said cataloger to review and edit said proposed metadata record to create a final metadata record;
allowing said cataloger to transmit said final metadata record to said proprietary database owner;
storing said final metadata record in a metadata record database; and
modifying said web page located at said universal resource locator to include metadata contained in said final metadata record.
